(19) United States
(12) Patent Application Publication
(10) Pub. No.: US 2007/0084164 A1
(43) Pub. Date: Apr. 19, 2007

(54) Vacuum cleaner dirt collection system

(76) Inventors: Scott Genoa, Merrick, NY (US); Mark Genoa, Melville, NY (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/240,301

(22) Filed: Sep. 30, 2005

(51) Int. Cl. B01D 46/00

(52) U.S. Cl. 55/429

(57) ABSTRACT

Dirt collection system for a vacuum cleaner includes a container defining an interior receivable of dirt and having an inlet opening situated below an upper edge thereof, a deflector member arranged in the container at least partially over the opening such that when air flows into the container through the opening, the air contacts and is deflected by the deflector member, and a filter arranged above the deflector member. The deflector member can include a first deflector plate extending over the opening and a second deflector plate spaced apart from the first deflector plate. The first deflector plate is arranged to deflect air entering the container through the opening in a direction toward the second deflector plate with the second deflector plate being arranged to deflect air in a direction toward the filter.

### FIELD OF THE INVENTION

This invention relates generally to a vacuum cleaner dirt collection system which receives a dirt-laden air stream during use of the vacuum cleaner and filters the air stream, and more particularly to a vacuum cleaner dirt collection system including a replaceable HEPA filter which removes dirt and other undesirable particulate matter from an air stream flowing from a vacuum cleaner power nozzle to form a filtered air stream which passes into the ambient atmosphere.

### BACKGROUND OF THE INVENTION

Upright vacuum cleaners are well known in the art. Typically, these upright vacuum cleaners include a vacuum cleaner housing pivotally mounted to a vacuum cleaner foot. The foot is formed with a suction or nozzle opening which is designed to pass over a surface to be cleaned. A motor is mounted to the foot or the housing for generating a suction force at the nozzle opening which is effective to pick up dirt and debris from the surface and thereby produces a stream of dirt-laden air which is directed to a dirt collecting system located in the vacuum cleaner housing.

In some conventional vacuum cleaners, the dirt-laden air stream is directed into a vacuum cleaner filtration bag supported on or within the vacuum cleaner housing. More recently, however, bagless vacuum cleaners have become prevalent in the marketplace. These bagless vacuum cleaners direct the stream of dirt-laden air into a dirt collecting system which usually includes a dirt collecting container or dirt cup and a filter which filters the dirt particles from the air stream before exhausting the filtered air stream into the ambient atmosphere.

There are numerous variations of such dirt collecting systems for bagless vacuum cleaners which remove dirt particles from the air stream. However, one common problem with such dirt collecting systems is that as the dirt cup of the dirt collecting system fills up with dirt removed from the air stream, the performance of the vacuum cleaner generally drops since the filter becomes increasingly restricted and clogged with dirt.

There is therefore a need for a bagless vacuum cleaner wherein vacuum cleaner performance is maintained even as the dirt cup begins to fill with dirt.

### OBJECTS AND SUMMARY OF THE INVENTION

It is an object of the present invention to provide a new and improved vacuum cleaner dirt collection system for a bagless vacuum cleaner.

It is another object of present invention to provide a new and improved vacuum cleaner dirt collection system for a vacuum cleaner which operatively receives a dirt-laden air stream and filters the air stream with the dirt separated from the air stream being retained by the dirt collection system.

It is another object of the present invention to provide a new and improved vacuum cleaner dirt collection system including a replaceable HEPA filter which removes dirt and other undesirable particulate matter from air flowing from a vacuum cleaner nozzle to form a filtered air stream which passes into the ambient atmosphere.

It is still another object of the present invention to provide a new and improved vacuum cleaner dirt collection system including a filter which is positioned so that it does not become easily block with dirt and thereby allows longer use of the vacuum cleaner between filter replacements in comparison with prior art vacuum cleaners.

It is yet another object of the present invention to provide a new and improved vacuum cleaner dirt collection system in which a dirt-laden air stream is deflected to enhance and optimize the removal of dirt therefrom.

In order to achieve at least one of these objects and possibly others, a dirt collection system for a vacuum cleaner in accordance with the invention includes a dirt cup or dirt container defining an interior receivable of particulate matter and having an inlet opening situated below an upper edge thereof and a deflector member arranged in the container at least partially over the opening and in a path of an air stream flowing through the opening such that when air stream flows into the container through the opening, the air stream is deflected by the deflector member. A filter is arranged above the deflector member, e.g., in a filter housing arranged above the container.

A preferred embodiment of a deflector member includes a first deflector plate arranged over the opening, and which when the opening is arranged at a rear of the container, is inclined upward toward a front of the container to thereby deflect the air in a direction toward the front of the container. A second deflector plate is arranged in front of the first deflector plate and in a path of the air being deflected by the first deflector plate. If this second deflector plate is inclined downward toward a rear of the container, it causes air deflected by the first deflector plate to be deflected in a direction toward a top of the container, i.e., toward filter material of the filter.

The container may be supported by a support member which includes n air flow channel having an outlet communicating with the opening of the container. The air flow channel is received in a slot recessed from a rear surface of the container with the outlet of the air flow channel being in communication with, or actual alignment with, an opening at the top of the slot. The filter housing can be secured to the support member by locking members engaging with both the filter housing and support member, or other comparable securing mechanisms.

The dirt collection system also includes a coupling section for coupling the support member to a vacuum cleaner air outlet duct or port to establish an air flow passage from the vacuum cleaner air outlet duct or port to the air flow channel in the support member.

Another version of a dirt collection system for a vacuum cleaner in accordance with the invention includes a dirt cup or dirt container defining an interior receivable of particulate matter and having an inlet opening situated below an upper edge thereof, a filter housing arranged above the container, a filter arranged in the filter housing, a support member for supporting the container and including an air flow channel having an outlet communicating with the inlet opening of the container and a securing mechanism for securing the filter housing in engagement with the support member. The securing mechanism may be a pair of locking members releasably engaging with the support member and with the filter housing.

Yet another version of a dirt collection system for a vacuum cleaner in accordance with the invention includes a container defining an interior receivable of particulate matter and having an inlet opening situated below an upper edge thereof, a deflector member arranged in the container and including a first deflector plate extending over the opening and a second deflector plate spaced apart from the first deflector plate, and a filter arranged above the deflector member. The first deflector plate is arranged to deflect a stream of air entering the container through the opening in a direction toward the second deflector plate with the second deflector plate being arranged to deflect air in a direction toward the filter. Deflecting the air stream aids in removal of dirt and other particulate matter therefrom.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a front perspective view of a vacuum cleaner dirt collection system according to the present invention;

FIG. 2 is a partially exploded, rear perspective view of the vacuum cleaner dirt collection system shown in FIG. 1;

FIG. 3 is a fully exploded front perspective view of the vacuum cleaner dirt collection system shown in FIG. 1; and

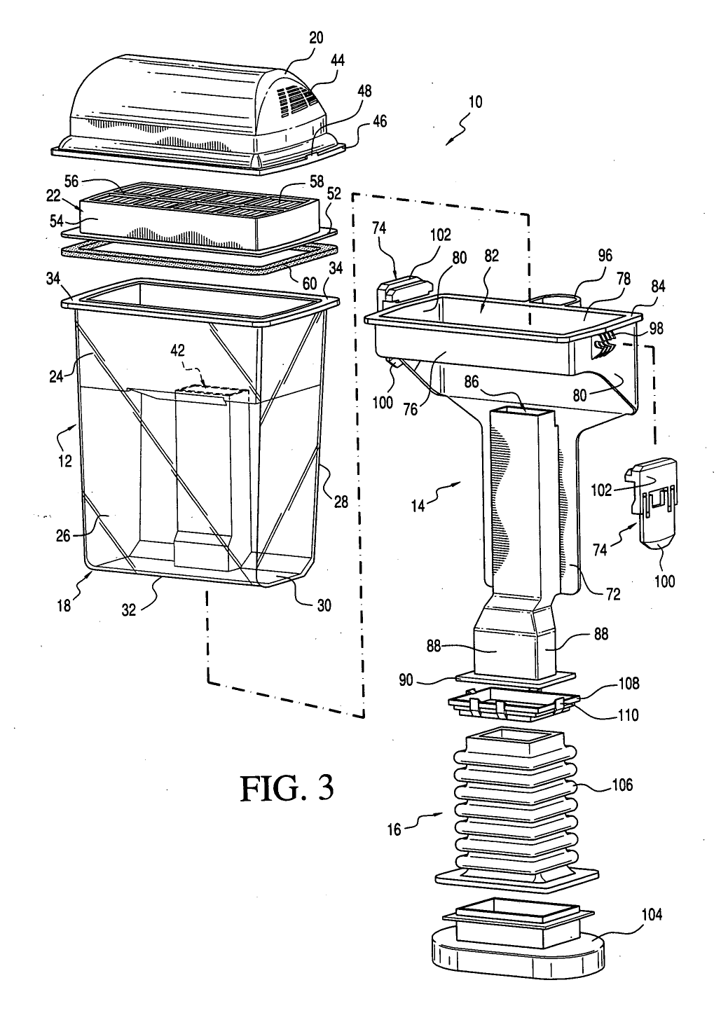

FIG. 4 is a sectional view taken along the line 4-4 in FIG. 1.

### DETAILED DESCRIPTION OF THE INVENTION

Referring the accompanying drawings wherein like reference numerals refer to the same or similar elements, a vacuum cleaner dirt collection system in accordance with the invention is designated generally as 10 and includes a container section 12, a support section 14 which supports the container section 12 and a conduit section 16 which engages with an outlet duct or port on the vacuum cleaner to receive and conduct a dirt-laden air stream generated at the nozzle of the vacuum cleaner.

Container section 12 includes a dirt cup or dirt container 18 which collects dirt and particulate matter, a filter housing 20 arranged above the dirt container 18, a filter 22 arranged in the filter housing 20 and a deflector member 24 arranged in the container 18.

Container 18 is preferably made of a rigid, transparent material and includes a plurality of substantially planar walls, including a front wall 26, an opposed rear wall 28, side walls 30 and a bottom wall 32. An upper rim 34 extends around the periphery of the container 18 and projects outward to define a lip of the container 18. A channel or slot 36 is formed in the rear wall 28 and is defined by opposed intermediate walls 38 substantially parallel to the side walls 30 and an intermediate wall 40 substantially parallel to the front and rear walls 26, 28. An inlet opening 42 is formed at the top of the slot 36 and serves as an inlet for the dirt-laden air stream into the interior of the container 18.

Filter housing 20 includes air vents 44 positioned around its periphery and above the filter 22 so that air which has passed through the filter 22, i.e., filtered air, can be exhausted out of the filter housing 20 to the ambient atmosphere.

Filter housing 20 also include a lower rim 46 having projections 48 on opposite side which facilitate securing of the filter housing 20 to the support section 14, described more fully below.

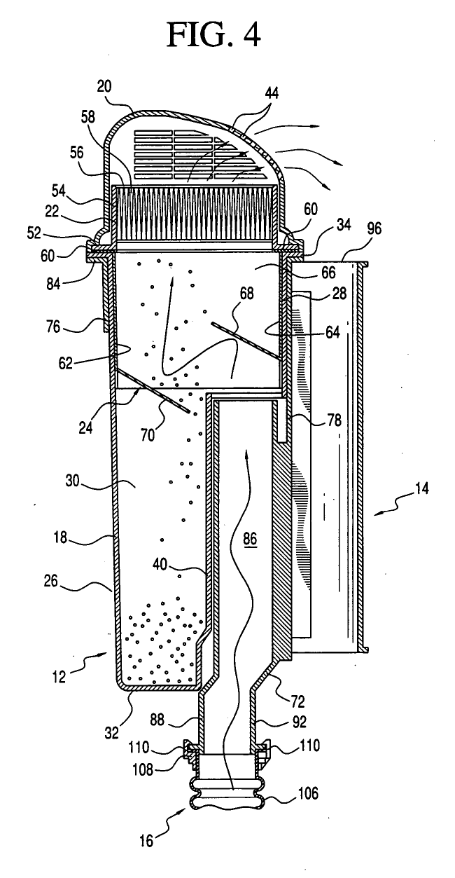

Filter 22 is preferably constructed to be a HEPA filter, which construction is readily known or ascertainable to those skilled in the art. Filter 22 has a frame 50 including a base 52, vertical walls 54 and a lattice upper wall 56. Filter material 58 is arranged in an enclosure defined by the vertical walls 54 and upper wall 56 (see FIG. 4). Base 52 projects outward from the vertical walls 54 and is dimensioned to fit within the lower rim 46 of the filter housing 20 (see FIG. 4).

Base 52 defines an opening which allows the filter material 58 to be exposed to the interior of the container 18. Indeed, by securing the filter material to the vertical walls 54 and/or the upper wall 56, the base 52 does not obstruct any portion of the lower face of the filter material 58 so that the entire cross-sectional surface area of the filter material 58 is exposed to the interior of the container 18 and can be used for filtering purposes (see FIG. 4). In this manner, the filter material 58 is substantially co-extensive with the cross-sectional area of the container 18. This is a significant improvement over prior art dirt containers wherein the filter material extends over only a small portion of the dirt container, e.g., the center of the dirt cup.

An important feature of the structure of the container section 12 is that the filter 22, and specifically the filter material 58 thereof, is situated above the container 18 so that a dirt-laden air stream can be directed through the container 18 in an upward direction into contact with the filter material 58 while providing a benefit in that dirt being removed from the dirt-laden air stream by the filter material 58 falls toward the bottom of the container 18. That is, dirt cannot accumulate on the filter material 58 since gravitational forces will urge dirt being separated from the dirt-laden air by the filter material 58 to fall off of the filter material 58 and downward toward the bottom of the container 18.

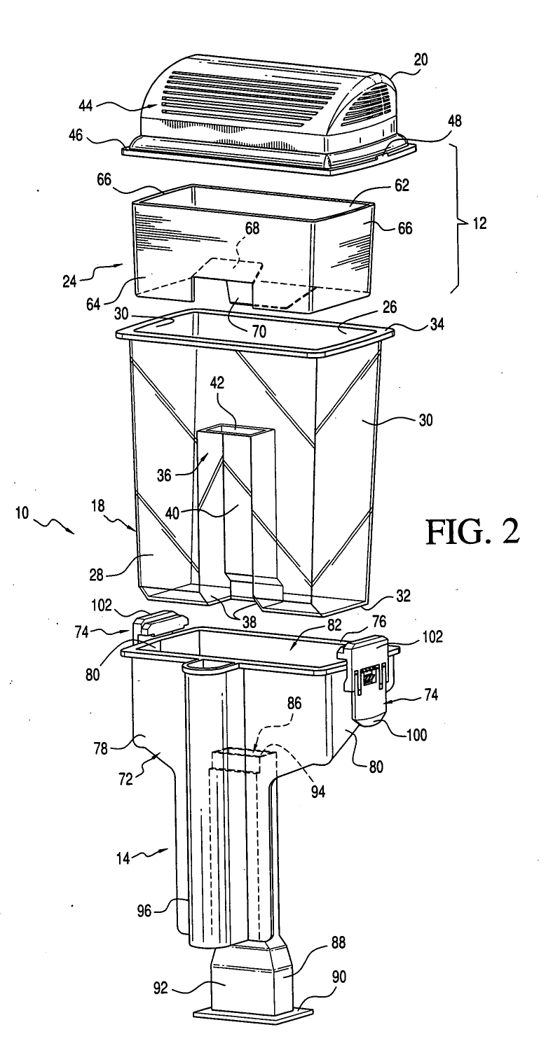

Container section 12 includes a cushion 60 interposed between the base 52 of the filter 22 and the upper rim 34 of the container 18 (see FIG. 2). As such, the filter 22 is provided with a cushioned support on the container 18.

Deflector member 24 sits in the container 18 at a predetermined height, with this positioning being achieved by appropriate dimensioning and construction of the peripheral walls of the deflector member 24 relative to the peripheral walls of the container 18, e.g., the tapering of the walls. Also, the upper edge of deflector member 24 is substantially flush with the upper rim 34 of the container 18 as shown in FIG. 2.

Deflector member 24 includes a front wall 62, an opposed rear wall 64 and side walls 66. A first deflector plate 68 extends forward and upward from a central region of the rear wall 64 and a second deflector plate 70 extends rearward and downward from a central region of the front wall 62. The first deflector plate 68 extends forward preferably to substantially and preferably even completely overlie the opening 42. The second deflector plate 70 is arranged relative to the first deflector plate 68 such that at least a portion of the air stream deflected by the first deflector plate 68 impinges on the second deflector plate 70, and is re-directed thereby upward toward the filter material 58. To this end, the second deflector plate 70 should have its free, lower edge below the free, upper edge of the first deflector plate 68. Also, it is possible, but not required that the fixed upper edge of the second deflector plate 70 is arranged at a vertical height below the height of fixed, lower edge of the first deflector plate 68 (as shown in FIG. 4). As the arrangement of the first and second deflector plates 68, 70 on the deflector member 24 and orientation of the first and second deflector plates 68,70 relative to one another is variable and depends in general on the overall construction of the deflector member 24, container 18 and/or support section 14, one skilled in the art would be able to determine an advantageous or optimum arrangement and orientation of deflector plates for a deflector member for any construction and shape of a container section and support section.

An advantage of the downward orientation of the second deflector plate 70 is that if dirt removed from the air stream by the filter material 58 falls against the second deflector plate 70, it slides along it and falls from its lower edge through the space between the lower edge of the second deflector plate 70 and the intermediate wall 40 to the bottom of the container 18.

Support section 14 includes a support member 72 and a pair of locking members 74 which secure the filter housing 20 to the support member 72. Support member 72 is made of a substantially rigid material and has a front wall 76, a rear wall 78 and side walls 80. A slot 82 is defined by the front wall 76, an upper part of the rear wall 78 and the side walls 80. A rim 84 is formed on the walls 76, 78, 80 at the upper edge of the support member 72, and supports the upper rim 34 of the container 18 (see FIG. 4).

An air flow channel 86 is formed on a front surface of the rear wall 78 and is defined by peripheral walls 88. A lower rim 90 is formed at the bottom of the peripheral walls 88 and at the bottom of a rear wall 92 which extends below rear wall 78 (see FIG. 2).

To enable the container 18 to slide into the slot 82 with the rear wall 30 of the container 18 alongside the rear wall 78 of the support member 72, the slot 36 of the container 18 and air flow channel 86 are provided with substantially corresponding cross-sectional shapes over at least a portion thereof to allow the air flow channel 86 to fit in the slot 36 until the outlet 94 of the air flow channel 86 is proximate the inlet opening 42 of the container 18 (see FIG. 4). The support member 72 and container 18 are also designed such that when the container 18 is slid into slot 82, the rim 34 of the container 18 abuts against an upper rim 84 of the support member 72.

Another channel 96 is formed along the rear surface of the rear wall 78 from the upper edge to the lower edge of the support member 72, and can serve to accommodate a hose or handle of the vacuum cleaner.

Locking grooves 98 are formed the outer surfaces of side walls 80 of the support member 72 proximate the upper rim 84.

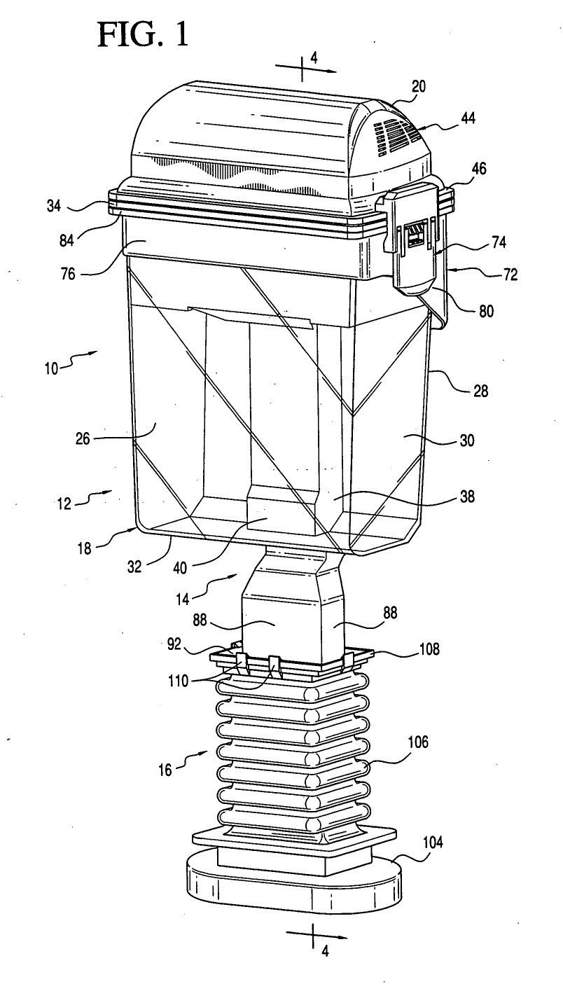

Locking members 74 engage with the locking grooves 98 and releasably overlie the projections 48 on the rim 46 of the filter housing 20 (see FIG. 1). To release each locking member 74 from engagement with the filter housing 20, a handle portion 100 of the locking member 74 is lifted upward to cause a gripping portion 102 of the locking member 74 to separate from its position overlying a respective projection 48. Once the gripping portions 102 of locking members 74 no longer overlie the projections 48, the filter housing 20 can be lifted upward. The container 18 with the deflector member 24 can also be lifted upward at which time, the deflector member 24 can be removed from the container 18 to enable the container 18 to be emptied and cleaned.

Conduit section 16 includes a first coupling member 104 which engages with the outlet duct or port of the vacuum cleaner (not shown), a conduit 106 connected to the first coupling member 104 and a second coupling member 108 connected to the conduit 106.

Coupling member 108 includes flexible tabs 110 projecting above the upper edge of the coupling member 108 and having inward facing projections which are designed to snap over the lower rim 90 of the support member 72 to thereby secure the coupling member 108 to the support member 72 and more generally, the coupling section 16 to the support section 14 (see FIG. 4). Conduit 106 communicates with the air flow channel 86 when the coupling member 108 is secured to the lower rim 90.

Separation of the coupling member 108 from the support member 72 is achieved by flexing the tabs 110 outward and urging the support section 14 and coupling section 16 apart from one another.

The connections between the conduit 106 and the coupling members 104, 108 may be removable or permanent connections.

Alternatively, one or both of the coupling members 104, 108 could be formed integral with the conduit 106.

In use, when the dirt collection system 10 is attached to a vacuum cleaner, dirt is drawn with air into the vacuum cleaner by its power nozzle and directed through the outlet port into conduit 106 of the coupling section 16. The dirt-laden air stream flows through conduit 106 into the air flow channel 86 in the support member 72 of the support section 14 (see FIG. 4). The dirt-laden air stream exits the air flow channel 86 through its outlet 94 and then flows through the opening 42 of the container 18 into the interior of the container 18. The dirt-laden air stream impacts the first deflector plate 68 and is deflected by it toward the second deflector plate 70.

Before this air stream impacts the second deflector plate 70, dirt may be drawn by gravitational force and pass between the lower edge of the second deflector plate 70 and the intermediate wall 40. Further, upon impact of the air stream with the second deflector plate 70, dirt can slide along its surface, in view of its downward orientation, and fall through the space between the lower edge of the second deflector plate 70 and the intermediate wall 40 to the bottom of the container 18.

The air stream is re-directed by the second deflector plate 70 toward the filter material 58 of the filter 22. As the air impacts the filter material 58, additional dirt is removed therefrom so that a filtered air stream passes through the air vents 44 of the filter housing 20 into the ambient atmosphere.

The removed dirt falls downward through the space between the lower edge of the second deflector plate 70 and the intermediate wall 40 to the bottom of the container 18, possibly sliding along the second deflector plate 70.

By virtue of the presence of the filter 22 on top of the container 18, dirt is urged away from the filter material 58 by the effect of gravity, which is aided by vibrational force arising during normal use of the vacuum cleaner. As such, the filter material 58 remains substantially unclogged allowing for extended use of the vacuum cleaner between filter replacements, in comparison to vacuum cleaners wherein the dirt rests on the filter material.

Once the container 18 is full and it is desired to empty it, the locking members 74 are released and the filter housing 20 is lifted upward to expose the deflector member 24. The container 18 with the deflector member 24 is then lifted upward out of the slot 82. The deflector member 24 is removed from the container 18 and emptied of accumulated dirt. The deflector member 24 can alternatively be removed from the container 18 before the container 18 is slid out of the slot 82.

Once the container 18 is clean, the deflector member 24 is put back therein and then this sub-assembly is slid into the slot 82. The filter 22 is replaced if clogged and then a filter 22 is placed onto the cushion 60 and onto the rim 34 of the container 18. The filter housing 20 is placed over the filter 22 and held in position with its rim 46 over the rim 34 of the container 18. Locking members 74 are then manipulated to cause the gripping portions 102 thereof to extend over the projections 48. The locking members 74 are then pressed into place securing the filter housing 20 to the support member 72. The vacuum cleaner with the dirt collection system 10 is now ready for re-use.

While a particular embodiment of the invention has been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A dirt collection system for a vacuum cleaner, comprising:
a container defining an interior receivable of particulate matter, said container having an inlet opening situated below an upper edge thereof;
a deflector member arranged in said container at least partially over said opening and in a direction of air flowing through said opening such that when an air stream flows into said container through said opening, the air stream is deflected by said deflector member; and
a filter arranged above said deflector member.

2. The system of claim 1, wherein said deflector member includes a first deflector plate arranged over said opening.

3. The system of claim 2, wherein said opening is arranged at a rear of said container, said first deflector plate being inclined upward toward a front of said container to thereby deflect the air in a direction toward the front of said container.

4. The system of claim 3, wherein said deflector member further comprises a second deflector plate arranged in front of said first deflector plate and in a path of the air being deflected by said first deflector plate.

5. The system of claim 4, wherein said second deflector plate is inclined downward toward a rear of said container to thereby cause air deflected by said first deflector plate to be deflected in a direction toward a top of said container.

6. The system of claim 1, further comprising a support member for supporting said container, said support member including an air flow channel having an outlet communicating with said opening of said container.

7. The system of claim 6, further comprising securing means for securing said filter housing in engagement with said support member.

8. The system of claim 7, further comprising a filter housing arranged above said container, said filter being arranged in said filter housing, said securing means comprising a pair of locking members engaging with said support member and with said filter housing.

9. The system of claim 7, further comprising a coupling section for coupling said support member to a vacuum cleaner air outlet duct or port to establish an air flow passage from a vacuum cleaner air outlet duct or port to said air flow channel.

10. The system of claim 1, wherein said deflector member includes a wall arranged alongside a wall of said container and a deflector plate extending from said wall over said opening.

11. The system of claim 1, wherein said opening is arranged at a rear of said container, said deflector member including a rear wall arranged alongside a rear wall of said container and a first deflector plate extending from said rear wall over said opening.

12. The system of claim 11, wherein said first deflector plate is inclined upward toward a front of said container to thereby deflect the air in a direction toward the front of said container.

13. The system of claim 12, wherein said deflector member further comprises a front wall opposite said rear wall and arranged alongside a front wall of said container, and a second deflector plate extending from said front wall and arranged in a path of the air being deflected by said first deflector plate.

14. The system of claim 13, wherein said second deflector plate is inclined downward toward a rear of said container to thereby cause air deflected by said first deflector plate to be deflected in a direction toward a top of said container.

15. The system of claim 13, wherein said container further includes an intermediate wall between said front and rear walls, said second deflector plate being spaced from said intermediate wall to enable dirt to pass therebetween and fall toward a bottom of said container.

16. The system of claim 1, further comprising a filter housing arranged above said container, said filter being arranged in said filter housing.

17. The system of claim 1, wherein said container includes a slot on a rear surface leading to said opening, said slot terminating at a distance from said upper edge of said container.

18. A dirt collection system for a vacuum cleaner, comprising:
a container defining an interior receivable of particulate matter, said container having an inlet opening situated below an upper edge thereof;
a filter housing arranged above said container;
a filter arranged in said filter housing;
a support member for supporting said container, said support member including an air flow channel having an outlet communicating with said opening of said container; and
securing means for securing said filter housing in engagement with said support member.

19. The system of claim 18, wherein said securing means comprise a pair of locking members engaging with said support member and said filter housing.

20. A dirt collection system for a vacuum cleaner, comprising:
a container defining an interior receivable of particulate matter, said container having an inlet opening situated below an upper edge thereof;
a deflector member arranged in said container, said deflector member including a first deflector plate arranged above said opening and a second deflector plate spaced apart from said first deflector plate; and
a filter arranged above said deflector member, said first deflector plate being arranged to deflect air entering said container through said opening in a direction toward said second deflector plate and said second deflector plate being arranged to deflect air in a direction toward said filter.
